(19) United States
(12) Patent Application Publication
(10) Pub. No.: US 2026/0366491 A1
(43) Pub. Date: Nov. 19, 2026

(54) TRANSPORTATION OF WIND TURBINE NACELLES

(71) Applicant: Vestas Wind Systems A/S, Aarhus N. (DK)

(72) Inventors: Simon Kabus, Viborg (DK); Jesper Lykkegaard Neubauer, Hornslet (DK)

(73) Assignee: Vestas Wind Systems A/S, Aarhus N. (DK)

(21) Appl. No.: 19/327,325

(22) Filed: Sep. 12, 2025

(30) Foreign Application Priority Data
May 13, 2025 (DK) PA 2025 30309

(51) Int. Cl. F03D 13/40; B60P 3/40; B62D 21/20

(52) U.S. Cl. CPC F03D 13/403; B60P 3/40; B62D 21/20; F05B 2260/02

(57) ABSTRACT

A transportation system includes a lowbed trailer having a raised front section, a raised rear section, and a lowered middle section located between the raised front section and the raised rear section. The lowbed trailer includes one or more wheel sets. The lowered middle section provides a load bed, and a wind turbine nacelle is positioned on the load bed. The wind turbine nacelle is configured such that at least a portion of the wind turbine nacelle extends rearwardly from the load bed over a part of the raised rear section of the lowbed trailer by at least 0.5 m and/or extends forwardly over a part of the raised front section of the lowbed trailer by at least 0.5 m. A benefit of the invention is that the length of the nacelle may be increased without requiring a commensurate increase in the length of the load bed of the trailer.

### CROSS REFERENCE TO RELATED APPLICATION

This application claims priority to DK Application No. PA 2025 30309, filed May 13, 2025, the disclosure of which is incorporated by reference herein in its entirety.

### TECHNICAL FIELD

The invention relates to the transportation of wind turbine nacelles, and in particular to improved methods and apparatus for transporting wind turbine nacelles.

### BACKGROUND

Wind turbine nacelles are large, heavy structures that house key generating components such as the gearbox, generator, and associated control equipment. As turbine capacities have increased, so too have the dimensions and mass of nacelles, creating significant logistical challenges in their transportation from manufacturing facilities to wind farm sites.

Currently, it is known to transport nacelles by road using low bed trailers (also referred to as low-loaders or lowboy trailers). These trailers are designed with a lowered deck height to provide increased vertical clearance, enabling the transport of tall loads while complying with maximum vehicle height regulations. The nacelle is typically secured directly onto the trailer deck and transported overland to its destination.

The use of low bed trailers provides certain advantages. In particular, the reduced deck height allows taller loads to be transported without exceeding legal height limits, minimising the need for route modifications or special permits related to height restrictions. Low bed trailers are also widely available and capable of carrying very heavy loads, making them well-suited for the weight of typical wind turbine nacelles.

However, a significant limitation of low bed trailers is the restricted available load length. Due to the design constraints of maintaining a low deck height while ensuring sufficient structural strength, the usable length of the trailer deck is limited compared to that of standard flatbed trailers. This restricts the maximum allowable length of nacelles that can be transported in a single piece by road using conventional low bed trailers. As modern nacelles continue to grow in size to meet the demands of higher capacity turbines, this limitation increasingly poses logistical challenges.

Specifically, transporting longer nacelles may require the use of specialised extendable trailers, modular trailer systems, or splitting the nacelle into subassemblies, each of which introduces additional complexity, cost, and handling risks. Furthermore, extended trailers can be difficult to manoeuvre, particularly on roads with sharp curves, steep gradients, or other infrastructure limitations.

Accordingly, there is a need for improved transport solutions that enable the efficient overland movement of longer wind turbine nacelles without the drawbacks associated with conventional low bed trailer designs.

It is against this background that the examples of the invention have been devised.

### SUMMARY

Aspects of the invention provide a transportation system and a method of configuring a wind turbine nacelle for transport.

The transportation system comprises a lowbed trailer comprising a raised front section, a raised rear section, and a lowered middle section located between the raised front section and the raised rear section. The lowbed trailer includes one or more wheel sets. The lowered middle section provides a load bed, and a wind turbine nacelle is positioned on the load bed. The wind turbine nacelle is configured such that at least a portion of the wind turbine nacelle extends rearwardly from the load bed over a part of the raised rear section of the lowbed trailer by at least 0.5 m and/or extends forwardly over a part of the raised front section of the lowbed trailer by at least 0.5 m.

The method in accordance with examples of the invention comprises: providing a lowbed trailer, the trailer comprising a raised front section, a raised rear section, and a lowered middle section located between the raised front section and the raised rear section; wherein the lowbed trailer includes a rolling arrangement and wherein the lowered middle section provides a load bed. The method further includes positioning a wind turbine nacelle on the load bed, such that at least a portion of the wind turbine nacelle extends rearwardly from the load bed over a part of the raised rear section of the lowbed trailer by at least 0.5 m and/or extends forwardly over a part of the raised front section of the lowbed trailer by at least 0.5 m.

A benefit of the invention is that the length of the nacelle may be increased without requiring a commensurate increase in the length of the load bed of the trailer. In the context of a lowbed trailer, this means that a standardized trailer configuration can be used to transport the nacelle along permissible routes, without increasing the vertical height of the nacelle, whilst achieving an increase in the interior volume of the nacelle by increasing the length by which the end or ends of the nacelle extend over the raised front section or the raised rear section of the lowbed trailer, as applicable. Such a feature can provide a useful gain in the nacelle internal volume, without a large increase in nacelle mass since additional strengthening structures are not required.

In some examples, the wind turbine nacelle is configured such that at least a portion of the wind turbine nacelle extends rearwardly from the load bed over a part of the raised rear section of the lowbed trailer by at least 1 m and/or extends forwardly over a part of the raised front section of the lowbed trailer by at least 1 m. Preferably the extent of extension is less than 4 m, for example less than 3 m.

In some examples, the wind turbine nacelle comprises a first nacelle portion and a second nacelle portion, wherein the first nacelle portion is mounted to the load bed, and wherein the second nacelle portion extends over the raised rear section or the raised front section. In such an example, the first nacelle portion defines a nacelle main length, and wherein the load bed defines a maximum load length, and wherein the nacelle main length is at least 80% of the maximum load bed length. By virtue of this geometry, the larger part of the wind turbine nacelle, that is, the first nacelle portion, can maximise its volume by extending over a significant length of the load bed of the trailer.

The configuration of the wind turbine nacelle may be such that the second nacelle portion has a base surface that is raised with respect to a base surface of the first nacelle portion. As a result, there may be defined a step between the two base surfaces. The two base surfaces may be parallel to one another, though this is not essential. For example, the base surface of the second nacelle portion may be parallel to the base surface of the first nacelle portion. The second base surface may be planar in form although this is not essential, as it may provide a non-planar surface (e.g. curved or undulating) instead.

In some examples of the invention, the wind turbine nacelle may have continuous side surfaces such that its width is constant over substantially all of its length. As such, it may be the case that the width of the first nacelle portion is the same as the width of the second nacelle portion. However, in other examples this might not be the case and, for example, the second nacelle portion may be different in width to the first nacelle portion. It is envisaged that the second nacelle portion mya be tapered in form, for example, to provide an aerodynamic nacelle body towards the rear end thereof.

In other examples, the width of the second nacelle portion may be greater than the width of the first nacelle portion. For example, the side faces of the second nacelle portion may diverge outwardly from adjacent surfaces of the first nacelle portion, in effect providing an enlarged rear section of the wind turbine nacelle. This could be combined with a tapering height of the second nacelle portion, which may also provide an aerodynamic benefit.

In some examples, the width of at least the first nacelle portion may be greater than the width of the load bed. In a sense, therefore, the nacelle may overhang side edges of the load bed, so that wider nacelles can be transported. In such a configuration, sides or flanks of the wind turbine nacelle may extend alongside at least a part of the raised rear section of the trailer. With such a design, the second nacelle portion can be configured to extend ‘up and over’ the raised rear section, with the result that a cavity is formed in the raised rear section to accommodate at least part of the raised rear section or components thereof.

The size of the cavity can be configured as required, and may have a width that is approximately equal to or greater than the maximum load bed width, although the width may be smaller in some designs. The cavity may be adapted to accommodate a functional unit/module, fitment, or piece of equipment. For example, an HVAC module could be accommodated within the cavity. The location of the cavity is advantageous because it could provide for convenient removal and replacement of the module located within it. The cavity may include a power interface for connection to the functional module that can be coupled to the cavity.

The raised front section may provide a forward bogie or dolly providing at least one of the at least one wheel sets. In such a design, the wind turbine nacelle may extend over the raised front section such that at a surface of the nacelle extends over or past the at least one wheel set of the raised front section. Similarly, the raised rear section may provide a rear bogie or dolly providing at least one of the at least one wheel set. As such, the wind turbine nacelle may extend over the raised rear section such a surface of the nacelle extends over or past the at least one wheel set of the raised rear section.

The wind turbine nacelle may extend over the raised rear section or the raised front section, as applicable, for a distance of less than 4 metres.

Preferred and/or optional features of the invention are set out in the appended claims. It should be noted that preferred and/or optional features of the transmission of the first aspect of the invention, as they relate to the pivot pad thereof, may also be combined with the pivot pad of the second aspect of the invention, as defined above.

### BRIEF DESCRIPTION OF THE DRAWINGS

Examples of the invention will now be described, by way of example only, with reference to the attached drawings, in which:

FIG. 1 is a perspective view of a known wind turbine, to provide context for the examples of the invention. The wind turbine may be an offshore or an onshore wind turbine.

FIG. 2 is a simplified representative view a known type of nacelle for the wind turbine of FIG. 1 which provides further context for the examples of the invention.

FIG. 3 is a side view of a transportation according to an example of the invention, comprising a low bed trailer carrying a nacelle;

FIG. 4 is a side view of another example of the invention, incorporating a different type of load bed trailer;

FIG. 5 is a perspective view of a rear part of the transportation system shown in FIGS. 3 and 4;

FIGS. 6 and 7 are side view and perspective views, respectively, of another example of transportation in accordance with the invention; and

FIGS. 8 and 9 are simplified perspective views of the nacelle shown in FIGS. 6 and 7 and illustrate the coupling between a cavity of the nacelle and a functional module that can fit into the cavity.

### DETAILED DESCRIPTION

A specific embodiment of the present invention will now be described in which numerous features will be discussed in detail in order to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

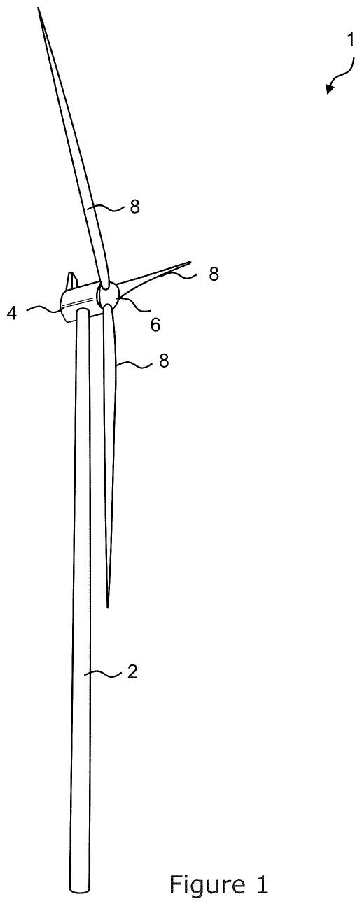

In order to place the embodiments of the invention in a suitable context, reference will firstly be made to FIG. 1, which illustrates a typical Horizontal Axis Wind Turbine (HAWT) 1 comprising a tower 2, a nacelle 4 rotatably coupled to the top of the tower 2 by a yaw system (not shown), a rotor hub 6 mounted to the nacelle 4 and a set of wind turbine rotor blades 8 coupled to the rotor hub 6. The nacelle 4 and rotor blades 8 are turned and directed into the wind direction by the yaw system.

The nacelle 4 serves as a housing that contains key equipment of the wind turbine. Nacelles are usually mounted It is typically mounted on top of the tower 2 positioned behind the rotor hub 6, aligned with the wind direction. The primary function of the nacelle is to support and protect the powertrain components, which includes the main bearing arrangement supporting a main shaft, a gearbox, a generator, and associated control systems. Additionally, the nacelle 4 may include cooling systems, sensors, and yaw mechanisms that allow the turbine to orient itself toward the wind for maximum efficiency.

The wind turbine 1 may be included in a group of wind turbines constituting a wind farm or wind park which operate collectively as a power generating plant connected by transmission lines (AC or DC) to a power grid, which may be a national or regional utility grid. The power grid comprises a network of power plants, transmission circuits, substations and breakers coupled by suitable transmission lines that transmit power to loads in the form of end users and other customers of electrical utilities.

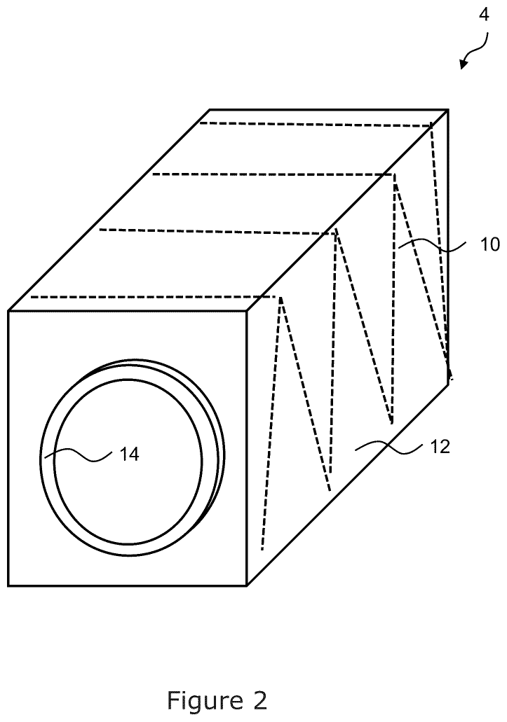

The nacelle 4 is shown in more detail in FIG. 2. The construction of such nacelles is well known in the art. Structurally, wind turbine nacelles are generally configured with an internal load-bearing framework, often referred to as a trellis structure or chassis. Such a structure is exemplified in FIG. 2 by the reference numeral 10.

This framework 10 is typically made from welded or bolted steel sections and serves to carry the mechanical loads from the rotor and powertrain, transferring them to the tower. Surrounding this load-bearing framework 10 is a non-load bearing nacelle cover 12, which provides aerodynamic shaping and environmental protection. Nacelle covers 12 are most commonly formed from lightweight, corrosion-resistant composite materials such as glass-reinforced plastic (fibreglass). The nacelle cover 12 is often manufactured in modular sections, such as top, side, and rear panels, to facilitate access for maintenance and assembly. This design allows for the efficient integration of structural performance and ease of servicing while maintaining protection from environmental exposure.

The front of the nacelle cover 12 is provided with an aperture through which a rotor connection flange 14 of the main shaft (not shown) protrudes. The rotor connection flange 14 provides a mounting point for the rotor 6 of the wind turbine 1.

As has been discussed, the length of the nacelle 4, taken longitudinally along the direction of the main shaft, can be restricted due to the available load length on the usual ‘lowbed’ trailers upon which they are typically transported to an installation site. Typically, the maximum load bed length is 8 m. Lowbed trailers are preferred because their relatively low load bed means that the nacelle is better able to fit under height restricted bridges that may be located along the road transport route. However, this acts to limit the maximum possible length of the nacelle.

The examples of the invention provide a solution to this issue.

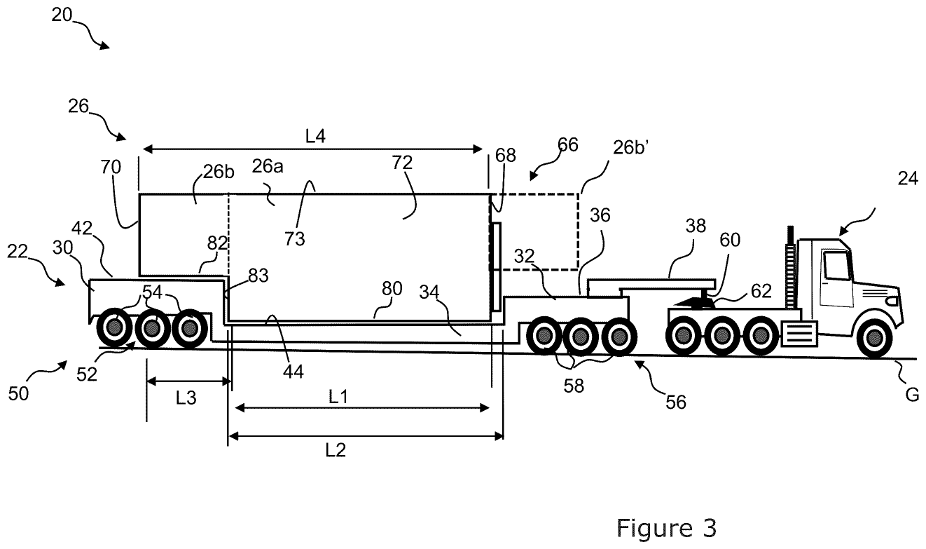

FIG. 3 shows a transportation system 20 in accordance with an example of the invention. The transportation system comprises a trailer 22, which is a lowbed trailer, also known as a lowboy trailer, or a double-drop trailer in some countries. For the purposes of this discussion, the term ‘lowbed trailer’ and, more simply, ‘trailer’ will be used for simplicity.

The trailer 22 is optionally coupled to a tractor unit 24, which is a truck in the illustrated example. The trailer 22 carries a nacelle 26, the detailed configuration of which will be discussed further later.

A lowbed trailer is a specialized type of trailer designed to transport heavy and oversized loads, particularly those that exceed the height limitations of standard road vehicles. Its unique design incorporates a lowered section, which allow for the transport of taller items while remaining within legal height restrictions. The following discussion highlights the key features of a lowbed trailer 22.

In summary, the lowbed trailer 22 includes a raised rear section 30, a raised front section 32 and a lowered middle section 34.

The raised front section 32 is the forward portion of the trailer 22 and typically sits at the standard height of a typical low bed trailer. In this example, the raised front section 32 provides an upper deck 36. The upper deck 36 may be used for transporting smaller components and accessories, and may serve as an area where the load is initially secured when the trailer 22 is loaded. The vertical height of the upper deck 36 may be between 1 m and 1.2 m.

The raised front section 32 also provides a coupling 38 for connection to a tractor unit 24, such as a truck. The coupling 38 is shown here as a gooseneck coupling as is known in the art. Other coupling types are envisaged as being acceptable, however.

The raised rear section 30 also defines a rear deck 42, which is beneficial for transporting loads near the back of the trailer 22, ensuring that the entire load remains within height regulations. The raised rear section 30 may also include mechanisms to attach ramps or other equipment for loading and unloading. The rear deck may have a similar height to the front deck 36, being around 1 m to 1.2 m.

The lowered middle section 34 provides a surface area or ‘load bed 44’ upon which the load is secured. The load bed 44 generally flat and wide to accommodate large, heavy items. The material used in the lowered middle section 34 typically comprises mostly steel to ensure durability and strength. The load bed 44 itself is designed to withstand heavy loads and provide stability during transport, and may be provided by sheet steel or wooden planks, by way of example. The vertical height of the load bed 44 above the ground may be between 0.3 and 0.5 m. It will be apparent that the load bed 44 is partitioned from the adjacent raised rear section 30 and the raised front section 32 by respective steps. The steps may be between 0.3 and 0.6 m in height.

The trailer 22 is provided with a rolling arrangement 50 to allow it to be moved along the ground. The rolling arrangement 50 is constituted by a plurality of wheel sets that are distributed between the raised rear section 30 and the raised front section 32. The wheel sets includes suitable axle configuration and suspension components to improve balance and stability for the trailer 22. In particular, the raised rear section 30 may be provided with a rear dolly 52 providing one or more rear wheel sets 54. In the illustrated example, the rear dolly 52 has three wheel sets 54 by way of example.

Similarly, the raised front section 32 is provided with a front dolly 56 that provides a plurality of front wheel sets 58. In the illustrated example, the front dolly 56 has three wheel sets 58 by way of example. Typically trailer dollies (also known as bogies) may have between one and eight wheel sets depending on the expected loads that the trailer is designed to carry, although the precise number is highly variable between applications.

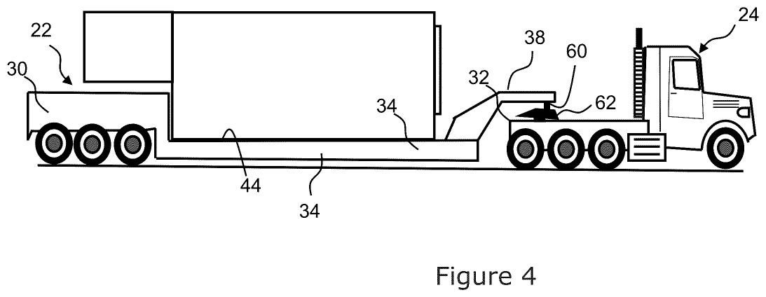

Another example of lowbed trailer 22 is shown in FIG. 4, where common reference numerals are used to refer to same or similar features. Here, the trailer 22 has a raised rear section 30 and a raised front section 32 which provide step changes in height between the load bed and the respective sections 30,32. However, in this illustrated example, the raised front section 32 is not provided with any wheel sets. Instead, the raised front section 34 provides the coupling 38 for connection to the tractor unit 24, and is not provided with a front dolly as is the example of FIG. 3.

It will be noted that the raised front section 32 in this example, as constituted by the coupling 38, still provides the same step height between the load bed 44 of the lowered middle section 34 and the raised front section 32.

In both examples of FIGS. 3 and 4, the dimensions of the load bed 44 may be as standard for such a trailer, at between 2.6 and 3 metres in width, and between 7.5 and 8.5 metres in length.

It will be appreciated that, in the illustrated example, the trailer 22 is depicted in a simplified form and so does not show certain features that may be included in a typical lowbed trailer. For example, support legs may be provide to provide stability when the trailer 22 is not attached to the tractor unit 24. Such legs can be raised or lowered depending on the type of trailer and the needs of the load being transported.

Further, such a trailer may also be provided with loading equipment such as deployable ramps and cable winches. Ramps are particularly useful when heavy loads need to be loaded from the ground level, reducing the need for cranes or other lifting equipment. The ramps may be detachable or integrated into the rear deck, and they are typically designed to handle significant weight.

To ensure that the nacelle or other large components remain secure during transport, lowbed trailers may be equipped with multiple tie-down points (not shown). These points are strategically located along the deck to accommodate a variety of load shapes and sizes. In addition, the trailer may include ratchet straps, chains, or other securing devices to prevent shifting during transit.

In both examples shown in FIGS. 3 and 4, the trailer 22 attaches to the tractor unit 24 at the coupling 38. More specifically, the coupling 38 is provided with a kingpin 60 that releasably attaches to a hitch (e.g. a fifth wheel hitch) 62 provided on the tractor unit 24. It should be understood that a kingpin and fifth wheel hitch is a common configuration for trailer attachment. The connection between the trailer 22 and the tractor unit 24 could also be provided by the ball hitch provided at the tractor unit 24 and a coupling socket provided at the coupling 38.

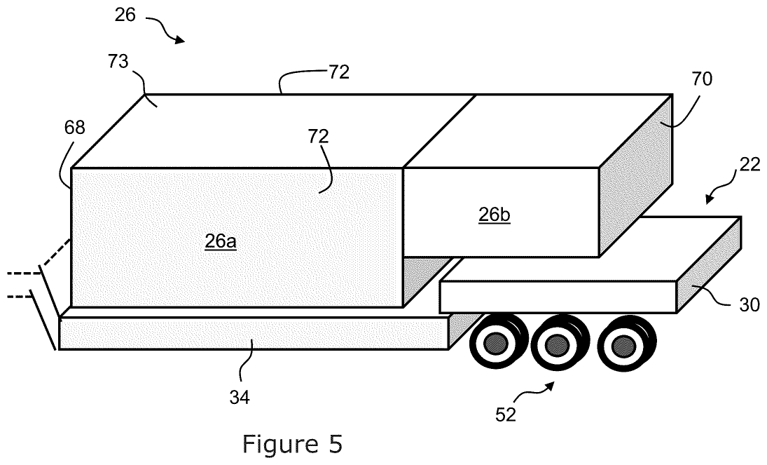

The loading of a nacelle on the trailer 22 will now be explained in more detail with reference to FIG. 3, but also with reference to FIG. 5 which shows a rear part of the trailer 22 and so applies to both the examples of FIGS. 3 and 4.

The nacelle 26 is shown loaded on the trailer 22. More specifically, the nacelle 26 is mounted on and supported by the load bed 44. The nacelle 26 is oriented in this example so that a hub end 66 faces towards the front of the trailer 22.

The nacelle 26 has a front face 68, a rear face 70, and two side faces 72, only one of which can be seen in FIGS. 3 and 4. The nacelle 26 also includes an upper face 73. The nacelle 26 has a length in a direction that extends along a longitudinal direction, between the front face 68 and the rear face 70.

It will be appreciated that the nacelle 64 is configured such that at least a portion of it extends rearwardly from the load bed 44 over a part of the raised rear section 30. Therefore, the nacelle 26 fills the entirety of the load bed 44 but can be considered to have a nacelle extension that extends over the raised rear section 30.

A benefit of this configuration is that it provides more space inside the nacelle 26 for accommodation of functional modules such as air conditioning, control systems, fluid systems and the like. However, it achieves this whilst using a standard lowbed trailer 22 which is beneficial in terms of efficiency of transportation over roadways.

In principle the extent to which the nacelle 26 extends over the raised rear section 30 depends on how much extra internal space is required for the nacelle 26. In some circumstances, the width of the nacelle 26 should not be increased, so the extra internal space is realised by the rearward extension of the nacelle 26 over the raised rear section 30.

It is envisaged that the nacelle 26 will extend over the raised rear section 30 by at least 0.5 m. In some examples, the extent of overlap will be less than 3 m, but more than 0.5 m. In other examples, the extent of overlap may be greater than 1 m and optionally less than 2 m. Moreover, it is envisaged that the nacelle 26 may extend over the raised rear section 30 to an extent that it overlaps at least one of the rear wheel sets 54 of the trailer 22. As can be seen in FIGS. 3 and 4, the rear face 70 of the nacelle 26 terminates at a point approximately aligned with the middle one of the rear wheel set 54.

In the illustrated example, the nacelle 26 has a first nacelle portion 26a and a second portion 26b. The first nacelle portion 26a is shaped generally as a rectangular prism and provides the front face 68 of the nacelle 26. The first nacelle portion 26a extends rearward from the front face 68 in a longitudinal direction to a point generally at the raised step defining the front of the raised rear section 30 of the trailer 22. The length of the first nacelle portion 26a is shown on FIG. 3 as L1, and may be referred to herein as the ‘main nacelle length’. As can be seen, the length L1 is slightly less than the length of the load bed 44 which is shown as L2. Notably, the length L1 occupies substantially the entire length of the load bed 44, although that is not essential. It is envisaged that the nacelle main length L1 may be above 80% of the load bed length L2.

The second nacelle portion 26b extends rearwardly from the first nacelle portion 26a and provides the rear face 70 of the nacelle 26. The length of the second nacelle portion 26b is shown as L3 in FIG. 3. It should be appreciated that the length L3 is less than the length L1 of the first nacelle portion 26a.

It will be noted that the total length of the nacelle 64, from the front face 68 to the rear face is identified as L4, and is the sum of L1 and L3.

The first nacelle portion 26a and the second nacelle portion 26b are delineated by a step change in their respective base heights. Explained further, the first nacelle portion 26a has a base surface 80 that is generally flat and horizontal along the length L1. Although it cannot be observed in the Figures, the base surface 80 of the first nacelle portion 26a may be provided with suitable hard points which bear the mass of the nacelle 26 when it rests on the load bed 44. The hard points may be provided at or near to the respective corners of the base surface 80, in a similar manner to shipping containers. However, such a location of hard points is not essential, and nacelle designs may differ such that hard points may be provided elsewhere on the base surface 80.

The second nacelle portion 26b also has a base surface 82. The base surface 82 is flat and generally horizontal, in the orientation of the figures, such that it is parallel to the ground plane G. The first nacelle portion 26a and the second nacelle portion 26b are configured such that the base 80 of the first nacelle portion 26a is parallel to the base surface 82 of the second nacelle portion 26b. However, the two base surfaces 80,82 are spaced from each other in the vertical direction so as to create a step between them, as can be observed in the figures. Preferably the spacing between the base surface 80,82 may be between greater than 0.3 m and less than 1.5 m. Still preferably, the spacing may be greater than 0.5 m. Due to the vertical spacing between the base surfaces 80,82, the effect is that the second nacelle portion 26b ‘overhangs’ the raised rear section 30 of the trailer 22.

Although in this example, the base surface 82 of the second nacelle portion 26b is parallel to the base surface 80 of the first nacelle portion 26a, this is not essential, and the base surface 82 may be at an inclined angle to the base surface 80 of the first nacelle portion 26a. Moreover, the base surface 82 may not be planar in form, and so may be defined by a curved surface. A connecting surface 83 extends between the base surface 80 and the base surface 82. The connecting surface 83 is mutually perpendicular to both base surfaces 80,82 in the illustrated example.

It will be noticed from the figures that although there is a step defined between the base surfaces 80,82 of the first nacelle portion 26a and the second nacelle portion 26b, there is no such differentiation on the upper face 73 of the nacelle 26. In particular, the upper face 73 does not vary in vertical height along the full length L4 of the nacelle 26. A reason for this is that the nacelle 26 is designed so its vertical height, when transported on the lowbed trailer 22, does not exceed that which is permitted on a typical roadway in the country in which the wind turbine is being installed, which by way of example is 4 m in Germany and 4.95 m in the UK.

The geometry of the nacelle 26 can be appreciated from an alternative viewpoint in FIG. 5. Here, it can be seen that nacelle 26 has a ‘slab-sided’ configuration in that the side faces 72 of the nacelle 26 are substantially flat and planar along their length, from the first face 68 to the second face 70.

In the above discussion, the second nacelle portion 26b extends rearwardly such that it extends over a portion of the raised rear section 30 of the trailer 22. In some examples, however, it is envisaged that the nacelle 26 may be configured so that a portion of it extends forwardly of the first nacelle portion 26a. This is shown by the nacelle extension depicted in dotted lines in FIG. 3, and labelled 26b′.

It will be noted that the exemplary transportation systems shown in FIGS. 3 to 5 feature a nacelle whose width is generally the same or less than the width of the load bed 44 which support it. However, advantages may be achieved by using a wider nacelle, not least of which is that this is one way to increase the internal volume of the nacelle without increasing its length. In some examples, therefore, it is envisaged that the nacelle 26 may be configured with geometry the same or similar to that of the examples illustrated in FIGS. 3 to 5, but the width of the nacelle 26 may be selected to that it is larger than the width of the load bed 44 of the trailer 22. In other words, the lateral dimension of the nacelle 26 could be increased compared to the nacelle 26 shown in FIGS. 3 to 5, whilst leaving the longitudinal dimensions unchanged so that the nacelle 26 overlaps sides of the trailer 22.

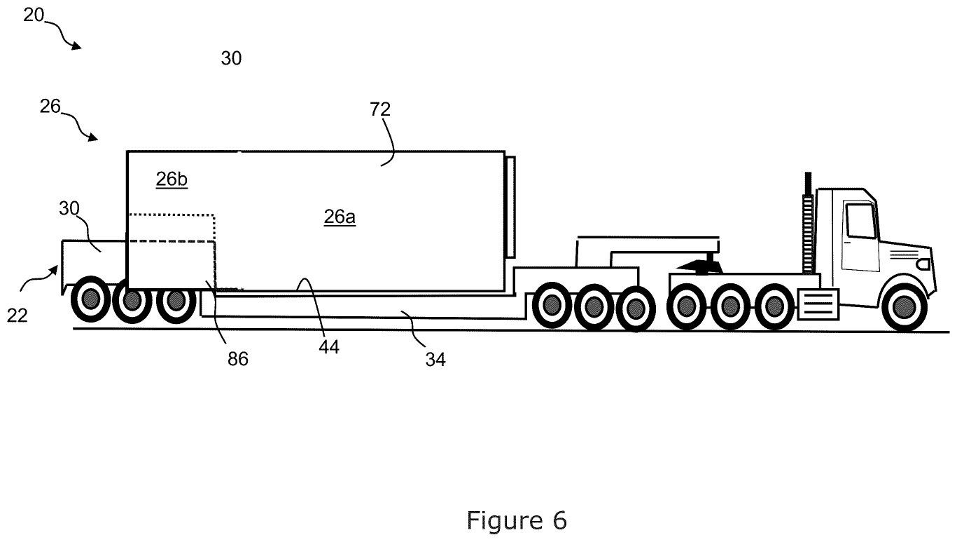

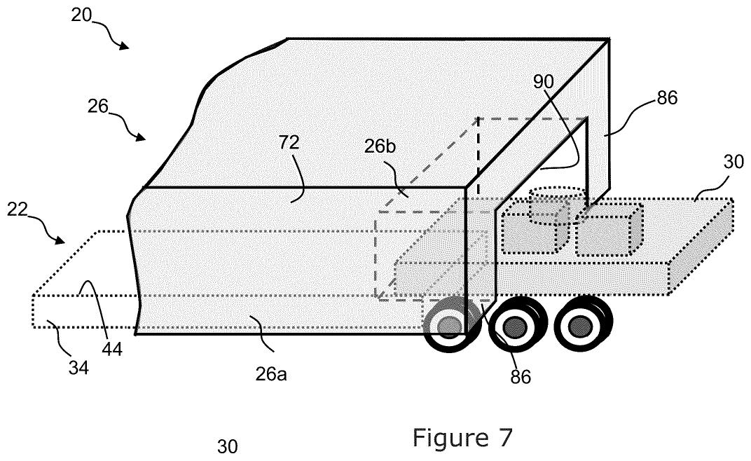

Alternatively, FIGS. 6 and 7 show another example of a possible configuration of a transportation system 20 in accordance with the invention featuring a nacelle 26 that is wider than the load bed 44 of the lowbed trailer 22 on which it is mounted. In the following discussion, the same reference numerals will be used to refer to the same or similar features in common with the previous illustrated example. Moreover, many of the features of the transportation system 20 in FIGS. 6 and 7 are common with the previously illustrated example, so for the purposed of brevity the following discussion will focus on the differences between the two examples.

It will be observed from FIG. 6 that the nacelle 26 has a very similar configuration to that which is shown in FIG. 3 in that the nacelle 26 has a ‘two box’ like configuration, comprising a first nacelle portion 26a and a second nacelle portion 26b. The first nacelle portion 26a is mounted on the load bed 44 of the trailer 22.

The second nacelle portion 26b extends over the raised rear section 30 as in the previous examples. However, it will be noticed that the nacelle 26 includes side flanks 86 that also overlap the raised rear section 30. In effect, therefore, the side flanks 86 constitute extended sides of the nacelle 26 which complement the geometry of the second nacelle portion 26b to overlap the sides of the raised rear section 30 as well as its upper surface.

A benefit of the side flanks is that they can be an extension of the lattice-like structure of the underlying nacelle frame rather than an add-on component which can result in a very strong rear section of the nacelle 26.

As is shown in FIGS. 6 and 7, the side flanks 86 and the upper part of the second nacelle portion 26b are shaped to provide an internal cavity 90 which accommodates part of the raised upper section 30 of the trailer 22. The size of the cavity 90 may be configured so that there is a gap between the deck of the raised rear section 30 of the trailer 22, which may be useful to extend over various items that may be located on the raised rear section 30, as illustrated.

One advantage of the cavity 90 is that the space may be used to accommodate a functional module. Such a functional module may take the form of an electronics cabinet, an HVAC module, a fluid power module, storage space, or other similar pieces of equipment. The benefit of this is that the volume of the cavity 90 can be used to further extend the usable volume within the outer boundary of the nacelle 26.

The width of the cavity 90 is shown here as being approximately equal to the width of the raised rear section 30. However, this need not be the case and the width of the cavity 90 may be greater than the width of the raised rear section 30.

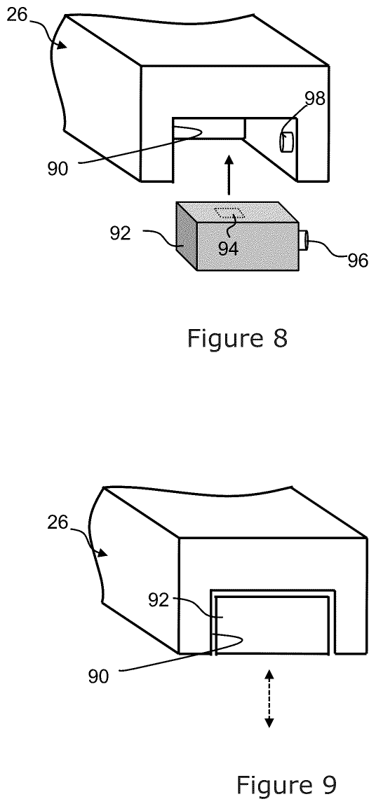

A simplified form of the nacelle 26 is shown in FIGS. 8 and 9. Here, the nacelle 26 is shown isolated from its trailer, for example being in an installed position on an associated tower structure. A functional module 92 is shown spaced from the cavity 90. The functional module 92 may be configured with a suitable size and shape to fit within the cavity 90, although an exact fit is not essential. As such, the dimensions of the cavity 90 may be larger than the dimensions of the functional module 92. Conversely, it may be the case that one or more of the dimensions of the functional module 92 may be larger than the equivalent dimensions of the cavity 90 so that the functional module 92 protrudes from the cavity 90.

It is envisaged that the functional module 92 could provide some additional storage for the nacelle 26, in which case the functional module 92 may be provided with an access hatch 94 that may overlap partly or fully with an equivalent hatch (not shown) in the cavity 90 of the nacelle 26, when the functional module 92 is installed in the cavity 90.

In the case where the functional module 92 contains power consuming or power generating equipment, a suitable connection interface 96 may be provided on a side of the functional module 92. The connection interface 96 may connect to a corresponding interface 98 in the cavity 90. The interface 98 may provide a suitable form of power, such as electrical power, hydraulic power, for example, or provide a fluid transfer means for the transfer of hydraulic fluid, gas or oil.

Whereas FIG. 8 shows the functional module 92 spaced from the cavity 90, FIG. 9 shows the functional module 92 installed within the cavity 90. The functional module 92 may be disconnected and dropped away from the cavity in any suitable manner. For example, a hoist system (not shown) internal to the nacelle 26 may be used to drop the functional 92 vertically downwards. Similarly, a suitable lifting eye may be mounted to the exterior of the functional module which may serve to connect to an external means to detach the functional module 82 from the cavity 90, for example a crane or an unmanned air vehicle.

The skilled person would appreciate that various adaptions and modifications to the illustrated examples of the invention as discussed above may be made without departing from the inventive concept as defined by the claims.

What is claimed is:

1. A transportation system (20) comprising:
a lowbed trailer (22) comprising a raised front section (32), a raised rear section (30), and a lowered middle section (34) located between the raised front section and the raised rear section,
wherein the trailer includes one or more wheel sets (50),
wherein the lowered middle section provides a load bed (44),
wherein a wind turbine nacelle (26) is positioned on the load bed,
wherein the wind turbine nacelle is configured such that at least a portion of the wind turbine nacelle extends rearwardly from the load bed over a part of the raised rear section of the lowbed trailer by at least 0.5 m and/or extends forwardly over a part of the raised front section of the lowbed trailer by at least 0.5 m.

2. The transportation system of claim 1, wherein the wind turbine nacelle is configured such that at least a portion of the wind turbine nacelle extends rearwardly from the load bed over a part of the raised rear section of the lowbed trailer by at least 1 m and/or extends forwardly over a part of the raised front section of the lowbed trailer by at least 1 m.

3. The transportation system of claim 1 or 2, wherein the wind turbine nacelle comprises a first nacelle portion (26a) and a second nacelle portion (26b), wherein the first nacelle portion is mounted to the load bed, and wherein the second nacelle portion extends over the raised rear section or the raised front section.

4. The transportation system of claim 3, wherein the first nacelle portion defines a nacelle main length (L1), and wherein the load bed defines a maximum load length (L2), and wherein the nacelle main length is above 80% of the maximum load length.

5. The transportation system of claims 3 or 4, wherein the second nacelle portion has a base surface (82) that is raised with respect to a base surface (80) of the first nacelle portion.

6. The transportation system of claim 5, wherein the base surface of the second nacelle portion is parallel to the base surface of the first nacelle portion.

7. The transportation system of claims 5 or 6, wherein the base surface of the second nacelle portion defines a step with the base surface of the first nacelle portion.

8. The transportation system of claim 5 to 7, wherein the first nacelle portion provides a connecting surface (93) extending between the base surface of the first nacelle portion and the base surface of the second nacelle portion.

9. The transportation system of claims 2 to 8, wherein the first nacelle portion has a first width, and wherein the first width is greater than a maximum load bed width.

10. The transportation system of claim 9, wherein the second nacelle portion has a second width, and wherein the second width is greater than the maximum load bed width.

11. The transportation system of claims 9 or 10, wherein the second nacelle portion has a cavity (90) to accommodate at least part of the raised rear section or components thereof.

12. The transportation system of claim 11 wherein the cavity has a width that is approximately equal to or greater than the maximum load bed width.

13. The transportation system of claims 11 or 12, wherein the second nacelle portion includes flanks (86) that extend alongside at least part of the raised rear section (30).

14. The transportation system of claims 11 to 13, wherein the cavity includes an interface (98) for connection to a functional module (92) that can be coupled to the cavity.

15. The transportation system of any one of the preceding claims, wherein the raised front section of the low bed trailer includes a coupling (38) for coupling to a tractor unit (24).

16. The transportation system of any one of the preceding claims, wherein the raised front section (32) provides a forward dolly (56) providing at least one of the at least one wheel sets (50; 58).

17. The transportation system of claim 16, wherein the nacelle extends over the raised front section such that at a surface of the nacelle extends over or past the at least one wheel set (58) of the raised front section.

18. The transportation system of any one of the preceding claims, wherein raised rear section (30) provides a rear dolly (52) providing at least one of the at least one wheel set (50; 54).

19. The transportation system of claim 18, wherein the nacelle extends over the raised rear section such that a surface of the nacelle extends over or past the at least one wheel set (54) of the raised rear section.

20. The transportation system of any one of the preceding claims, wherein the wind turbine nacelle extends over the raised rear section or the raised front section, as applicable, for a distance of less than 4 metres.

21. The transportation system of any one of the preceding claims, wherein the height of an upper surface (73) of the nacelle is substantially constant along the length (L4) of the nacelle.

22. Method of configuring a wind turbine nacelle (26) for transport, comprising:
providing a lowbed trailer (22) comprising a raised front section (32), a raised rear section (30), and a lowered middle section (34) located between the raised front section and the raised rear section, wherein the lowbed trailer includes one or more wheel sets (50) and wherein the lowered middle section provides a load bed (44);
positioning a wind turbine nacelle on the load bed, such that at least a portion of the wind turbine nacelle extends rearwardly from the load bed over a part of the raised rear section of the lowbed trailer by at least 0.5 m and/or extends forwardly over a part of the raised front section of the lowbed trailer by at least 0.5 m.

23. The method of claim 22, wherein the wind turbine nacelle extends over the raised rear section or the raised front section, as applicable, for a distance of less than 4 metres.

24. The method of claims 22 or 23, wherein the wind turbine nacelle extends over the raised rear section such that a surface of the nacelle extends over or past the at least one wheel set (50) of the trailer (22).

25. The method of any one of claims 22 to 24, wherein the nacelle extends over the raised front section such that at a surface of the nacelle extends over or past the at least one wheel set (58) of the raised front section.

26. The method of any one of claims 22 to 25, wherein the height of an upper surface (73) of the nacelle is substantially constant along the length (L4) of the nacelle.
